(19) United States
(12) Patent Application Publication
(10) Pub. No.: US 2007/0285049 A1
(43) Pub. Date: Dec. 13, 2007

(54) Jump starter with built-in battery charger

(76) Inventors: Michael Krieger, Miami Beach, FL (US); Kevin Ellsworth, Hollywood, FL (US)

Correspondence Address: VECTOR PRODUCTS, INC.;ROBERT POWELL, P.O. BOX 34385, c/o VENABLE LLP, WASHINGTON, DC, 20043-9998, US

(21) Appl. No.: 11/710,611

(22) Filed: Feb. 26, 2007

Related U.S. Application Data
(60) Provisional application No. 60/776,236, filed on Feb. 24, 2006.

(51) Int. Cl. H02J 7/00; H01M 2/10

(52) U.S. Cl. 320/105; 320/110

(57) ABSTRACT

A jump starter is provided. The jump starter may be designed as a versatile, portable jump starter addressing the most common needs of power for a consumer. The jump starter may provide DC power, AC power, portable battery charging capability, and other power providing capabilities.

### BACKGROUND OF THE INVENTION

Today, people are highly mobile and require that their electronic tools with which they conduct their business be likewise mobile. Part of meeting that requirement is to provide portable electronic devices, such as cellular phones and laptop computers, with the power those devices need. Portable devices are usually equipped with rechargeable batteries, but even the most expensive and heavy batteries are rarely sufficient to deliver electrical power over a significant time period. These batteries need to be recharged periodically from various power sources, sometimes on the road.

Rechargeable cells, such as nickel-cadmium cells, have a relatively constant potential during discharge and can be recharged many times, thus extending their useful life. In general, any rechargeable cell contains a combination of active materials which can be electrolytically oxidized and reduced repeatedly. In rechargeable cells, reactions at both electrodes are reversible and the input of current in the appropriate direction from an outside source will reverse the discharge reaction and, in effect, recharge the electrodes.

The rechargeable cells have been used in various type devices, such as toys, calculators, radios and other types of power-operated devices. Many of the power-operated devices on the market today have been designed to accommodate cylindrical cells of the “AA”, “C”, and “D” size. These sizes have now become standard-type cell sizes having overall dimensions which can be found in various publications, such as The American National Standard Specifications For Dry Cell Batteries—ANSI C18.1-1969 published by the American National Standards Institute, Inc., New York, N.Y.

Many portable electronic devices rely on one or more single-cell batteries for power. The plethora of different electronic devices, such as pagers, cellular phones, portable radios, portable CD players, flashlights, and other battery powered electronic equipment in use has created a great volume demand for single-cell battery power, resulting in the sale of both rechargeable and non-rechargeable single-cell batteries.

Rechargeable batteries, such as nickel cadmium (NiCd) are available in conventional and identical sizes and substantially identical voltages as the non-rechargeable single cell batteries and are often used interchangeably with non-rechargeable batteries. The interchangeable use of either rechargeable or non-rechargeable small single cell batteries creates a problem for the user to distinguish between the rechargeable or non-rechargeable batteries, especially when dealing with a battery charger. To insert a non-rechargeable battery into a single cell battery charger creates a hazardous condition that can result in injury or damage due to leakage of chemicals from the non-rechargeable battery when recharging is accidentally attempted.

Devices with jump starting capability are available in transportable forms that allow them to be kept in a car. These devices allow a drained car battery to be recharged to a level that may allow a car to start. They are not currently suitable for the charging of other battery using devices.

### SUMMARY OF THE INVENTION

In one exemplary embodiment, a jump starter is provided. The jump starter may be designed as a versatile, portable jump starter. The jump starter may provide DC power, AC power, portable battery charging capability, and other power providing capabilities.

In another embodiment, the portable jump starter may include a housing; an AC port provided on the housing; a DC port provided on the housing; an internal battery disposed within the housing and coupled to the DC port; jumper cables having one end coupled to the battery and receiving charging current therefrom and a second end including battery clamps; portable battery charger circuitry disposed in the housing and coupled to at least one of the battery or AC port, the battery charger circuitry providing charging current to the internal battery and/or to portable batteries inserted into the housing.

### BRIEF DESCRIPTION OF THE DRAWINGS

FIG. 1 is a perspective view of an exemplary embodiment of a portable jump starter with a closed cover.

FIG. 2 is a perspective view of an exemplary embodiment of a portable jump starter with an open cover.

FIG. 3 is a block diagram illustrating the components of the portable jump starter according to an exemplary embodiment.

FIG. 4 is a more detailed view of the charger of FIG. 1.

### DETAILED DESCRIPTION OF AN EXEMPLARY EMBODIMENT

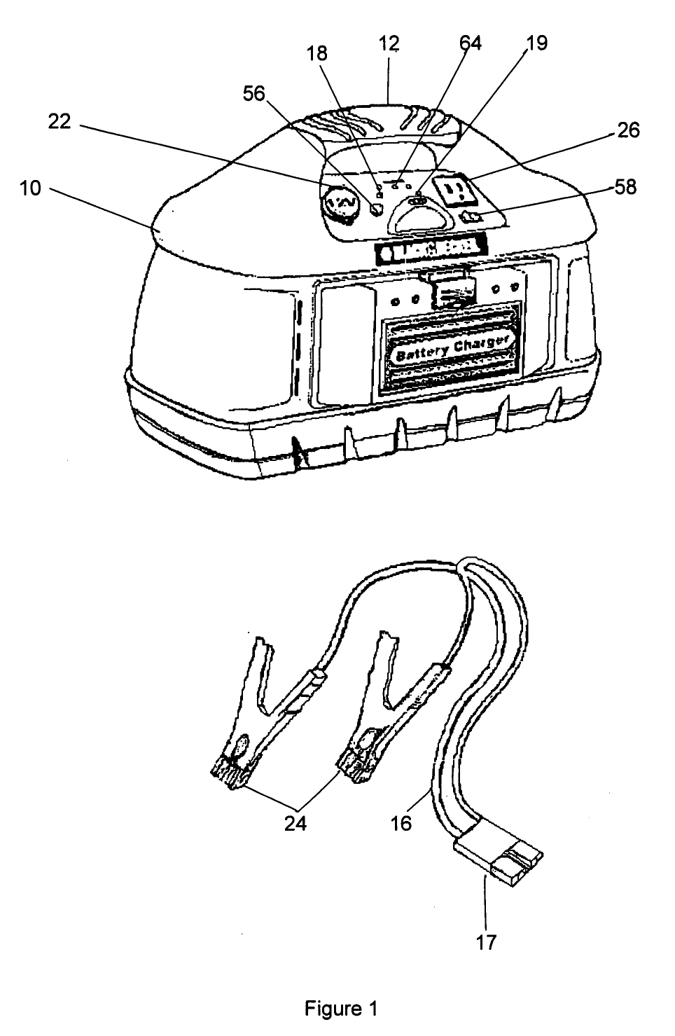

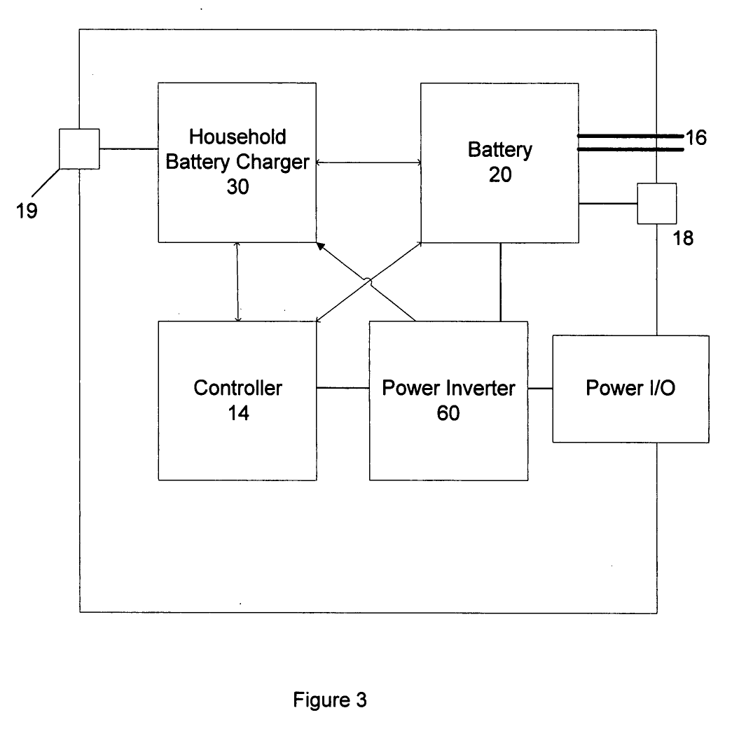

The portable jump starter shown in FIGS. 1-3 may include a housing 10. The housing 10 may include a handle 12 having a contoured grip. A power source 20, for example a battery, such as a sealed lead acid battery, a nickel cadmium battery, a nickel metal hydride battery or the like, may be disposed in the housing 10 (FIG. 3). The battery 20 may be adapted to provide DC power for a variety of applications. A power inverter 60 may be disposed in the housing 10. The power inverter may be adapted to convert AC power to DC power, DC power to AC power, or to step up or step down the voltage level of AC or DC power. One or more outlets 22 into which various devices may be plugged may be provided on housing 10. The outlets 22 may be similar to, for example, a cigarette lighter outlet in a car. A charger for mobile phone or other device may be plugged into the outlet 22 for charging.

Several different types of DC power outlets may be provided. For example, USB port 18 may be provided on the housing 10. The USB port 18 may be used to provide a USB power supply. In one embodiment, a voltage regulator optionally included may convert DC input power, for example from the battery 20, into a USB compatible 5V/500 mA DC power output. The voltage regulator may be a component of the power inverter 60. A charging port 19 for mobile telephones or other portable devices may also be provided. Additionally, the battery 20 may provide power for a controller 14, such as a microprocessor or other circuitry, which may be used to control the operation of the various components described below that may be provided in the jump starter.

The battery 20 may provide a portable DC power source that may be used to operate various devices. The DC power from the battery 20 may also be converted into AC power, for example, by the power inverter 60. Receptacles 26 that may be adapted to receive a typical AC plug are provided on the housing 10 to provide AC power to a device plugged therein. The receptacles 26 may provide access to AC power. Also, receptacle 26 may be used to receive an AC input current that may be converted to DC power, for example, by the power inverter 60, and used to charge the internal battery 20 in a known manner. Outlet 22 may also be used to receive DC power to charge internal battery 20.

The battery 20 may also be used to provide jumpstarting power for vehicles such as cars, RVs, and the like, which cannot start due to a depleted vehicle battery. For example, a booster apparatus as described in U.S. patent application Ser. No. 10/315,061, which is incorporated herein by reference, may be provided. The jump starter therefore may include a set of jumper cables 16 that may be used to connect the battery 20 in the housing 10 to the depleted vehicle battery. Such jumper cables 16 are well known to those of ordinary skill in the art.

The jumper cables may be detachable from the housing. An end of the jumper cables may include a plug 17 that may be received in the housing 10 to connect the cables to the internal battery 20. At an end of the cables 16 opposite the plug 17 there may be a pair of clamps 24 for connecting to the depleted battery. The housing 10 may also include clips or holsters for the jumper cables 16. The housing 10 may also be provided with pins, guides, compartments or the like in order to allow a user to wrap the jump starter cables 16 for storage, thus keeping the cables neat and accessible.

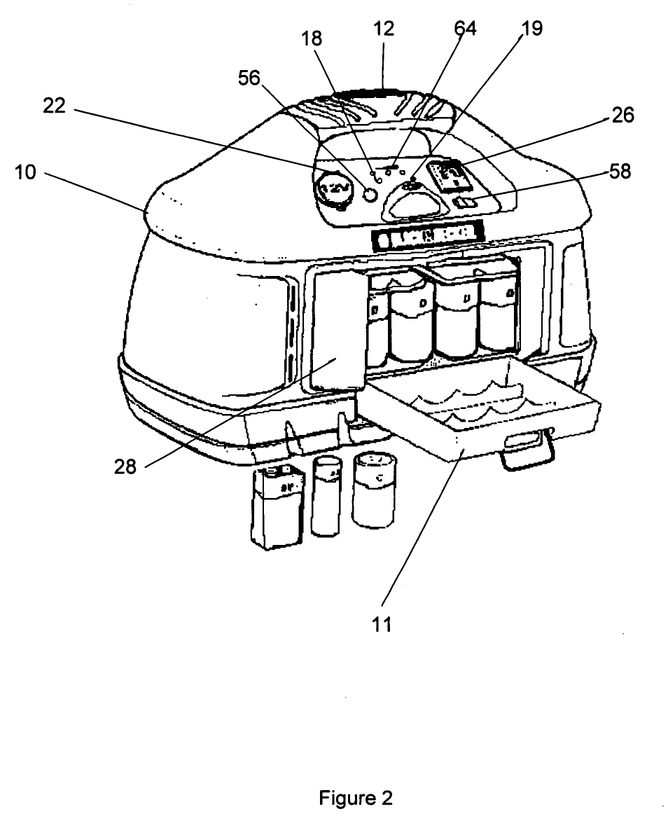

Referring now to the embodiment illustrated in FIG. 2, the housing may have a lid 11. The lid 11 may be opened or closed to expose or enclose a cavity 28 within the housing 10. Latches or other securing devices may be provided to secure the lid 11 in the closed position. The jump starter may also be provided with battery charger circuitry 30. The battery charger circuitry 30 may be adapted to charge portable rechargeable batteries, such as, for example, NiCad batteries and the like. As defined herein, portable batteries may include any rechargeable portable battery designated as such by any of the American National Standard Specifications as published by the American National Standards Institute, such as ANSI C18 series. Exemplary portable batteries are designated as AAA, AA, C and D and have wide household use.

The cavity 28 may be adapted to accommodate portable batteries of different sizes and types, such as a 9 volt battery and D, C, AA, etc. size cells. As shown in FIG. 2, the cavity 28 may have a rectangular shape. Cavity 28 may be configured to receive and charge batteries of different sizes as is known to one of ordinary skill in the art.

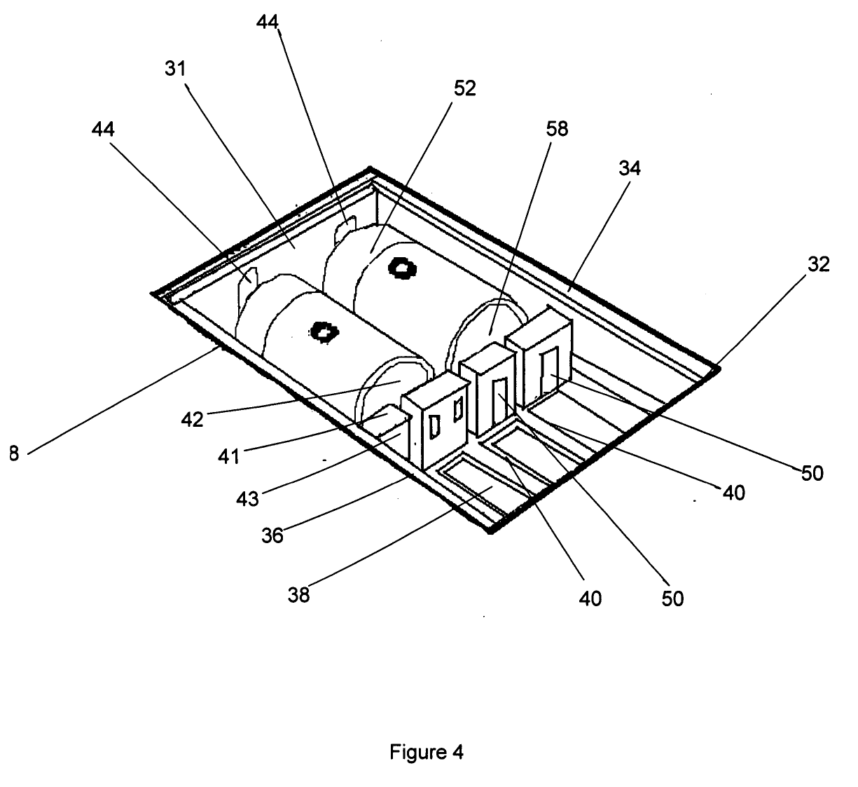

FIG. 4 illustrates a more detailed view of an embodiment of cavity 28. As shown in FIG. 4, the cavity 28 may have a rectangular shape, with a top 31, bottom 32 and two sides 34, 36. A back 38 may connect the top 30, bottom 32 and two sides 34, 36 together. The top 30 and bottom 32 may be provided with various contacts 44, 46, respectively, to connect to the contacts of different size and type batteries. Back 38 may be provided with slots 40 extending along at least part of its length. A slide member 41 may move along the slots 40.

The slide member 41 may have a front surface 42 facing top 31 and a back surface 43 facing bottom 32. Various sets of contacts 48, 50 may be provided on front surface 42 and back surface 43 respectively. The contacts 48, 44 on front surface 42 and top 31 may be adapted to connect to battery electrodes of opposite polarity. The contacts 50, 46 on back surface 43 and bottom 32 may be adapted to connect to battery electrodes of opposite polarity. For example, positive electrodes of batteries 50 may be connected to contacts 44 and negative electrodes of batteries 52 may be connected to contacts 48 on front surface 42. The slide member 41 may move along the slots to fit different size batteries. Cavity 28 may also be adapted to receive and charge batteries of different sizes in a variety of other ways which are known to one of ordinary skill in the art.

In a further embodiment, the portable battery charger circuitry 30 may detect if rechargeable or non-rechargeable batteries are placed in the cavity 28. Detection may be made by controller 14. The detection may be based on the characteristics of the portable battery, such as, for example, voltage, internal resistance, etc. If a non-rechargeable battery is detected, charging may be prevented. Detecting and preventing the charging of non-rechargeable batteries may be done in a known manner.

The portable batteries and internal battery 20 may be recharged via the DC input from the outlet 22, or via a wall cube that converts household AC current into DC. An input port 56 may be provided on the housing to receive input from the wall cube. The internal battery 20 may provide power for the portable battery charger circuitry 30.

An on/off switch 58 may control the operation of the jump starter. A set of indicator lights 64 may be provided to show the status of the internal battery 20 or portable batteries being charged. The controller 14 may monitor the various components of the jump starter and show results on a display. The display may include, for example, a linear meter, a digital read out or a bar graph which may allow a user to monitor the operation of the jump starter, such as the status on the internal battery, the battery in a vehicle being jump started, or the portable batteries. A battery gauge such as a linear meter for a digital read out or a bar graph may be provided to display to the user the status of the internal and/or the external battery being charged. The gauge or read out may be provided on a front surface of the housing.

Numerous different options are contemplated within the apparatus electrically, these options may include such schemes as totally enclosing the internal wiring terminating at a single point input/outlet for all charging functions or, conversely, at multiple points both internal and external. The power inverter, battery charger and other devices may be of varying watts, amperage ratings, etc. The battery configuration may include several different types of technology such as, for example, nickel cadmium, lead acid, etc. A port may be provided in the jump starter to allow for the addition of external batteries of greater capacity than the internal battery. Each of the aforementioned devices may be contained within the same housing for a portable jump starter. The jump starter may provide both DC and AC power in addition to battery charging capabilities.

We claim:

1. A portable jump starter, comprising:
a housing defining a cavity therein, the cavity being adapted to receive different size portable batteries;
an AC outlet provided on the housing;
a DC input port provided on the housing;
an internal battery disposed within the housing;
a power inverter disposed within the housing;
jumper cables having a first end removably coupled to the battery and adapted to receive charging current therefrom and a second end including battery clamps;
portable battery charging circuitry disposed in the housing, the battery charger circuitry coupled to at least one of the DC input and the internal battery and adapted to provide battery charging current to portable batteries in the cavity.

2. The jump starter of claim 1, wherein the battery charging circuitry is adapted to distinguish between rechargeable and non-rechargeable batteries.

3. The jump starter of claim 1, further comprising:
a lid hingedly connected to the housing and adapted to cover the cavity, the lid including contours adapted to fit the contour of different size batteries to hold the batteries within the cavity.

4. The jump starter of claim 1, further comprising:
a lid hingedly connected to the housing and adapted to cover the cavity;
a slide member disposed in the cavity, the slide member being movable to accommodate different size portable batteries;
a first set of recharging contacts disposed on a top side of the cavity and a corresponding set of battery contacts provided on a first side of the slide member and a second set of recharging contacts disposed on a bottom side of the cavity and a corresponding set of battery contacts provided on a second side of the slide member, opposite the first side of the slide member.

5. The jump starter of claim 1, further comprising a cigarette lighter adaptor coupled to the DC input port.

6. The jump starter of claim 1, further comprising a USB port configured to output DC power.

7. The jump starter of claim 1 further comprising a set of indicator lights configured to indicate the status of the jump starter and at least one of the battery, the battery recharger, or the power inverter.

8. The jump starter of claim 1 further comprising a set of indicator lights configured to indicate the status of the internal battery or the portable batteries being charged.

9. The jump starter of claim 1 further comprising a display configured to indicate the status of the jump starter and at least one of the battery, the battery recharger, or the power inverter.

10. An apparatus, comprising:
a housing;
circuitry disposed within the housing coupled to a battery, a battery charger, a power inverter, a controller, at least one of a AC or DC input port, and at least one of an AC or DC output port;
the battery adapted to receive a DC input from the DC input port or the power inverter and provide a DC output, and coupled to the controller, the battery recharger, at least one of the DC output ports;
the power inverter adapted to receive a DC or AC input from at least one of the AC inputs, the DC inputs, or the battery, and provide a DC or AC output, and coupled to the controller, the battery charger, and at least one of the AC or DC output ports;
the battery recharger adapted to receive a DC input from at least one of the battery, the DC input port, or the power inverter, to contain at least one rechargeable battery and provide DC input to the at least one rechargeable battery;
the controller adapted to receive DC input from at least one of the battery, the DC input port, or the power inverter, regulate the operation of the battery, the battery recharger, and the power inverter.

11. The apparatus of claim 10, wherein the battery recharger is adapted to distinguish between rechargeable and non-rechargeable batteries.

12. The apparatus of claim 10, further comprising:
a lid hingedly connected to the housing and adapted to cover the cavity, the lid including contours adapted to fit the contour of different size batteries to hold the batteries within the cavity.

13. The apparatus of claim 10, further comprising:
a lid hingedly connected to the housing and adapted to cover the cavity;
a slide member disposed in the cavity, the slide member being movable to accommodate different size portable batteries;
a first set of recharging contacts disposed on a top side of the cavity and a corresponding set of battery contacts provided on a first side of the slide member and a second set of recharging contacts disposed on a bottom side of the cavity and a corresponding set of battery contacts provided on a second side of the slide member, opposite the first side of the slide member.

14. The apparatus of claim 10, further comprising a cigarette lighter adaptor coupled to the DC input port.

15. The apparatus of claim 10, further comprising a USB port configured to output DC power.

16. The apparatus of claim 10 further comprising a set of indicator lights disposed on the housing configured to indicate the status of the least one of the battery, the battery recharger, or the power inverter.

17. The apparatus of claim 10 further comprising a set of indicator lights configured disposed on the housing to indicate the status of the internal battery or the portable batteries being charged.

18. The apparatus of claim 10 further comprising a display disposed on the housing configured to indicate the status of at least one of the battery, the battery recharger, or the power inverter.
